(19) United States
(12) Patent Application Publication
(10) Pub. No.: US 2003/0101110 A1
(43) Pub. Date: May 29, 2003

(54) No demand production order material on hand checking method

(76) Inventors: Shin-Chan Chen, Taipei (TW); Yi-Ming Liao, Taipei (TW); Cheng-Ju Chen, Taipei (TW)

Correspondence Address: BIRCH STEWART KOLASCH & BIRCH, PO BOX 747, FALLS CHURCH, VA, 22040-0747, US

(21) Appl. No.: 09/992,032

(22) Filed: Nov. 26, 2001

(51) Int. Cl. G06F 17/60

(52) U.S. Cl. 705/29; 705/8

(57) ABSTRACT

A material on hand checking method without demands and production orders aims at resolving the problem of not able to forecast material shortage without demands and production orders in electronic format by enterprises. Through the calculation method, when there is a request of trial-producing (trial-running) without any demand and production order, the Enterprise Resource Planning (ERP) server is capable of controlling and monitoring the inventory system, estimating required materials of trial-run prototype/module based on certain steps and procedures. Enterprises can, therefore, decrease overstock in the facilities, reduce the risk of material purchasing and increase profit margins.

### BACKGROUND OF THE INVENTION

1. Field of the Invention

This invention relates to a materiel on hand checking method owing to whole new trial-run prototypes/modules, and particularly a method that is capable of checking material shortage status without demands and production orders applied to an inventory management system in the manufacturing industry.

2. Related Art

To most enterprises and product manufacturers, there are many ways to increase profit margins, and managing costs is one of the ways, moreover, management of material costs among cost categories is a matter of interest to enterprises. To satisfy required product quantities by customers or end users, those enterprises and product manufacturers have to prepare sufficient materials maintaining normal processes of productions. In default of maintaining sufficient stock inventory would suspend operations of production lines, so that finished goods from productions can not be delivered on time and this may lose potential commercial opportunities, cause the imbalance between supply and demand (disequilibrium), or reduce, even lose, market shares to those enterprises and product manufacturers. On the contrary, overstocks would cause a hoard of cash funds, difficulties in circulating capital and increase in management of costs, and the loss of margin profits from invisible risks of changeable product markets to those enterprises and product manufacturers.

Daily faced problems to the manufacturing industry include : what parts or components need to be purchased, how to plan production schedules after purchasing material items, how to arrange delivery of finished goods from productions, how to manage excess/surplus stock, etc. For example, capacity forecast and formal orders are not the same thing, even a formal order would possibly change without any previous notice, therefore, it is often to cause loss due to a stock-out or excess/surplus stock resulting from mistaken list making and incorrect materials preparation. However, current Material Requirement Planning (MRP) still has the following drawbacks: actual build orders (production orders) and build orders (production orders) for trial-run prototypes/modules are simultaneously sent to the system. Nevertheless, the system can not distinguish actual build orders from trial-run build orders, where there is any material shortage, there is a superfluity of material purchase to increase inventory, instead of notifying purchase staff of making certain material purchase. To most trial-run prototypes/modules, as there is no much need of demands and production orders for them, the Material Requirement Planning (MRP) system is unlikely to forecast quantities of required materials, but depends on rule of thumb of stock clerks to estimate quantities of required materials and bills of material (BOM) for trial-run prototypes/modules, then issues required materials from inventory center/stock house according to an estimated sum. This kind of method takes too much cost of time and labor.

Hence, material on hand checking method for no demands and production orders in the manufacturing industry has become a heavily focused subject.

### SUMMARY OF THE INVENTION

In view of the foregoing, the invention aims at resolving the preceding disadvantages to provide a material on hand checking method without demands and production orders. The primary objects of the invention is to aim at proceeding quantity forecasts of required materials for trial-run prototypes/modules through the Enterprise Resource Planning (ERP) server of the enterprise end to manage inventory in the facilities. If there is any shortage, the Enterprise Resource Planning (ERP) server would make a marker and store it back to the storage media and notify managers that material on hand is only required for trial-run prototypes/modules, not for actual build orders, to further achieve the goal of heightening profits of enterprises by decreasing the risk of material purchasing and reducing a hoard of inventory.

The disclosed material on hand checking method without demands and production orders according to this invention at least consists of: receiving information of a trial-run prototypes/modules through the Enterprise Resource Planning (ERP) server, transferring information of the trial-run prototype/module back to a storage media according to the Enterprise Resource Planning (ERP) server, exploding bill of material (BOM) of the trial-run prototype/module through the Enterprise Resource Planning (ERP), and integrating the bill of material (BOM) and storing it back to the storage media through the Enterprise Resource Planning (ERP).

The foregoing, as well as additional objects, features and advantages of this invention will be more readily apparent from the following detailed description, which proceeds with reference to the accompanying drawings. Specific structures and functional details disclosed hereunder are not to be interpreted as limiting, but merely as a basis for the claims and as a representative basis for teaching one skilled in the art to variously employ the present invention.

### BRIEF DESCRIPTION OF THE DRAWINGS

FIG. 1 is a schematic representation of material on hand checking method without demands and production orders of this invention.

FIG. 2-a is a flowcharted representation of material on hand checking method without demands and production orders according to this invention.

FIG. 2-b is a sub-flowcharted representation of exploding bills of material (BOM) according to this invention.

FIG. 3 is presently known exploded view of bills of material (BOM) of the information system.

FIG. 4 is an exploded view of bills of material (BOM) according to this invention.

### DETAILED DESCRIPTION OF THE INVENTION

This invention proposes a material on hand checking method without demands production orders for trial-run prototypes/modules. In particular, the method, based on the advocacy of the up-to-date Business Process Re-Engineer (BPR), mainly aims at improving effective utilization and management of enterprise resources and re-engineering working processes of managing and checking material quantities without demands and production orders to decrease the risk of overstock and to reduce operation costs of the organization.

Prior to this invention, the introduction of production process of a notebook computer for showing the importance of trial-run prototypes/modules is described hereunder.

The production process of a whole new notebook computer (laptop) generally comprises two phases, one is research and development (R&D) and trial-production (trial-run) phase, and the other is quantity-production phase in the factories/manufactories. This production process pattern is almost applied to all electronic products. The details are as follows.

A. R&D and Trial-Production (Trial-Run) Phase:

1. Market information collection: both R&D and marketing departments collect market information to analyze the feasibility of a new product and to decide specifications of that product.

2. Prototype/module design: product specifications, such as PCB (printed circuit board) design, parts and components, materials, and outlook, are delivered to designers of relevant departments for detailed design.

3. Prototype/module testing: sections of original prototype/module design are tested for defects and instant rectification.

4. New production lines for trial-run prototype/module: that modified prototype/module would be delivered to facility to create sections of the prototype/module and to factories/manufactories for productions. All improper design, especially the PCB part, would be re-rectified during the process of trial-production. Also, there are various testing for the new product to be forthwith rectified to heighten feasibility for productions on trial-production phase. However, the system is unable to estimate quantities of parts and components and provide materials with accuracy, even if the trial-run prototype/module had passed all kinds of testing and whole production process had been determined. The reason is that some of parts and components on the bill of material (BOM) of a trial-run prototype/module are, as often as not, duplicate with that of other different prototypes/modules, besides, the trial-run prototype/modules only needs quite small quantities of required materials. Therefore, either there is no material being issued by the system, or overstock from purchasing makes a hoard of inventory.

B. Quantity Productions Phase in the Factories/Manufactories:

Once a trial-run prototype/module passed the trial-production phase without any problems in production process and product usage, the trial-run prototype/module would be able to be distributed to production lines in the factories/manufactories for quantity-productions.

The aforementioned indicates the importance of the process of trial-productions in the manufactory industry.

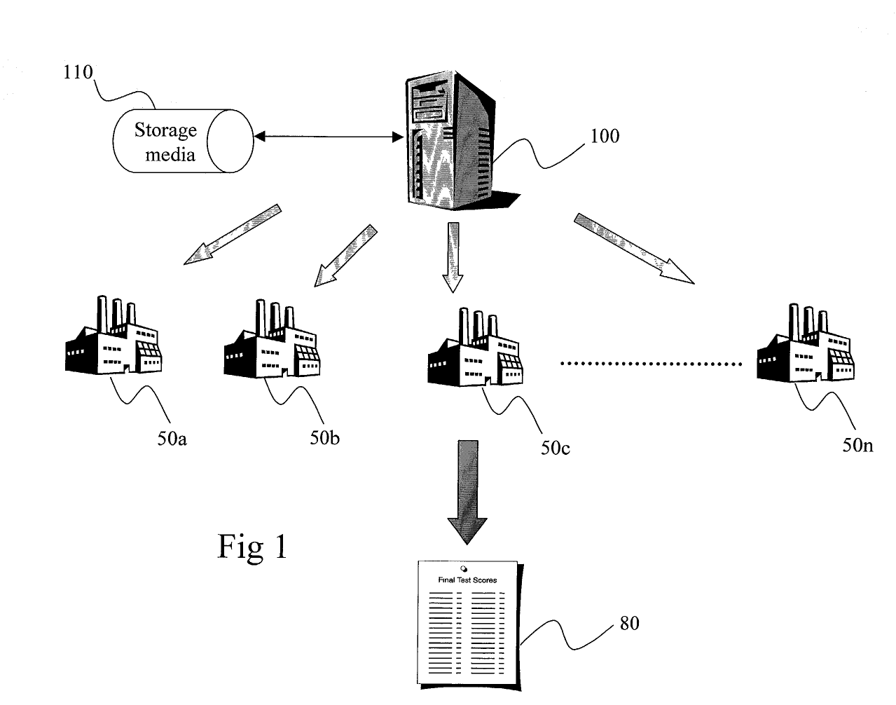

The feasibility and practicality of this invention will be elaborated by means of an embodiment depicted in the following. With reference to FIG. 1, the schematic representation of material on hand checking method without demands and production orders of this invention illustrates details as follows.

First, after determining a trial-run prototypes/modules, the Enterprise Resource Planning (ERP) server 100 of the enterprise end integrates and manages all material resources in the enterprise end, captures stock data from a storage media 110. There are various material stocks and finished goods in different facilities 50a˜n, among which all stocks can be analyzed and contrasted with quantities of required materials between the stock house/inventory center and the trial-run prototype/module by the Enterprise Resource Planning (ERP) server 100. As there is no actual demand and production order for the trial-run prototype/module, such a build order, therefore, can not be directly placed into the Enterprise Resource Planning (ERP) server 100 for calculation. Instead, the Enterprise Resource Planning (ERP) server 100 has to explode the bill of material (BOM) 80 of the trial-run prototype/module before calling inventory status on the storage media 110 for item-by-item contrast, then find part numbers of stock-outs through a searching method to make a mark for decision makers' references.

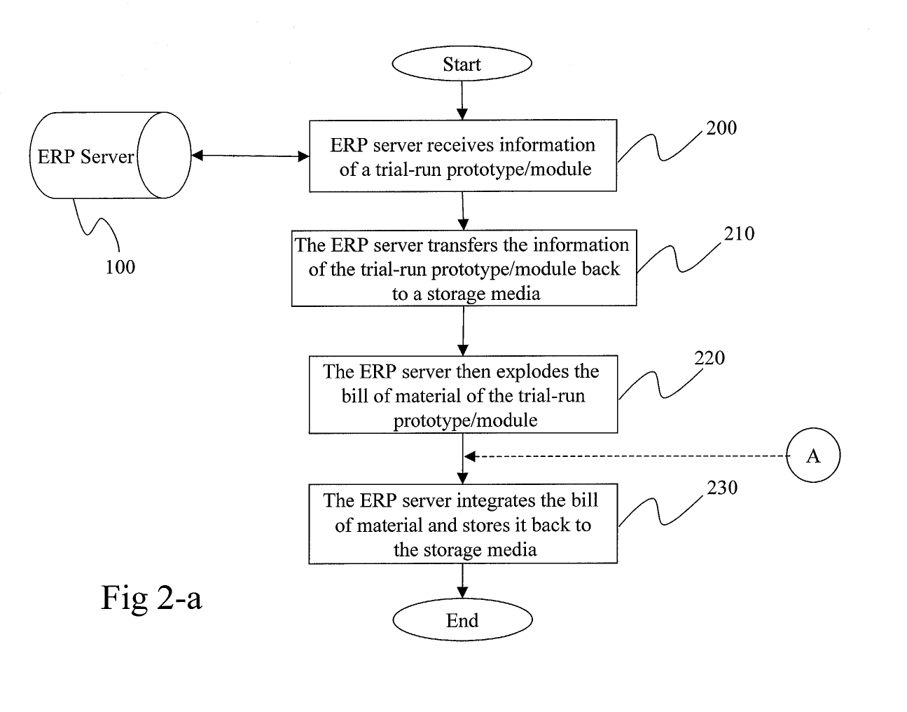

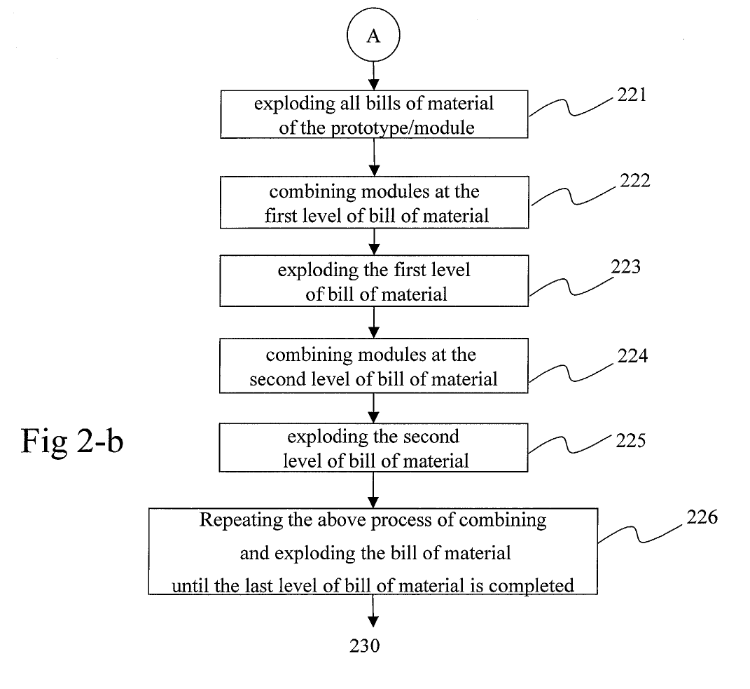

With reference to FIG. 2-a, the flowcharted representation of material on hand checking method without demands and production orders according to this invention represents the detail hereunder.

First, the Enterprise Resource Planning (ERP) server 100 receives information of a trial-run prototype/module (step 200), which comprises at least: the facility and required quantity of the trial-run prototype/module. After receiving such information, the Enterprise Resource Planning (ERP) server 100 transfers the information of trial-run prototype/module back to a storage media 110 (step 210), which provides a plurality of columns to store different contents. The Enterprise Resource Planning (ERP) server 100 then explodes the bill of material (BOM) of the trial-run prototype/module (step 220). When the bill of material (BOM) is completely exploded, the Enterprise Resource Planning (ERP) server 100 integrates the bill of material (BOM) and stores it back to the storage media 110 (step 230) and terminates the function flow of the material on hand checking method. The way for the Enterprise Resource Planning (ERP) server 100 to integrate the bill of material (BOM) 80 is to calculate quantity of available stock for the trial-run prototype/module from the quantity difference of inventory stock and reserved stock. The way for the bill of material (BOM) 80 stored back to the storage media 110 is to store part numbers and quantities of stock-outs for trial-run prototype/module into the columns provided by the storage media 110 for decision making purposes.

The aforementioned exploding bill of material (BOM) method of the trial-run prototype/module refers to FIG. 2-b, the sub-flowcharted representation of exploding bills of material (BOM) according to this invention.

First, the method explodes all bills of material (BOM) of trial-run prototypes/modules (step 221), then combines components or parts at the first level of bill of material (BOM) (step 222), when the first level of bill of material (BOM) is completely combined, then the method explodes components or parts at the first level of bills of material (BOM) (step 223). When the first level of bill of material (BOM) is completely exploded, the method then combines components or parts at the second level of bill of material (BOM) (step 224), when the second level of bill of material (BOM) is combined, the method then explodes components or parts at the second level of bill of material (BOM) (step 225). Repeating the above process of combining and exploding the bill of material (BOM) until the last level of bill of material (BOM) is completely drilled down (step 226).

The above mentioned bill of material (BOM) 80 can be a product tree of an enterprise and further comprises at least one common material and at least one specific material. The meanings of specific materials and common materials are: the specific materials are specified components or parts needed for respective prototypes/modules, no components and parts among which are overlapped in common; the common materials relate to general components or parts needed for all prototypes/modules, and are evaluated by pre-set columns through the Enterprise Resource Planning (ERP) server.

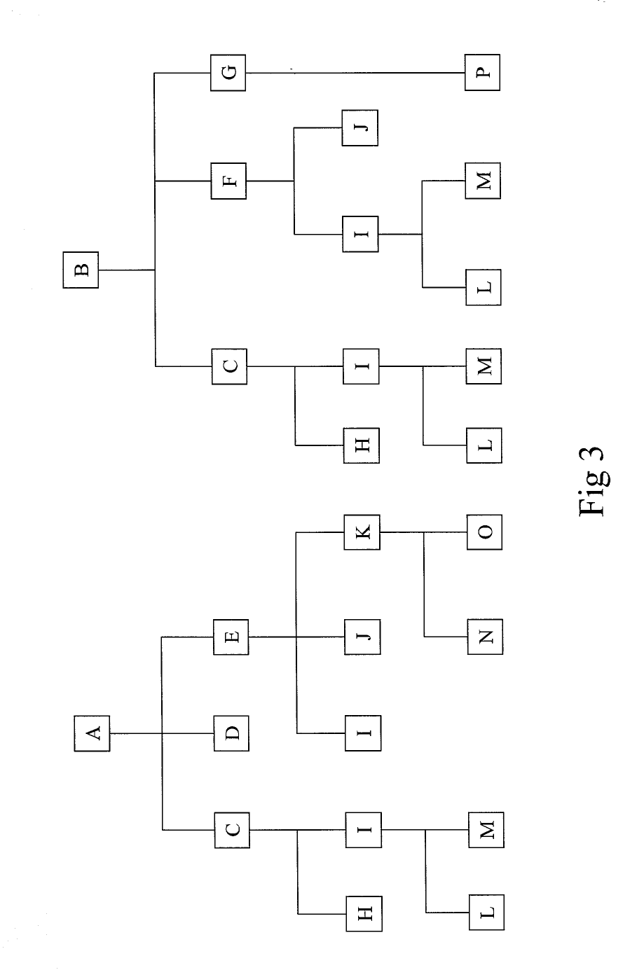

FIG. 3 is a presently known exploded view of bills of material (BOM) that illustrates the exploding method of bill of material (BOM) as follows,

First, the system explodes the first level of bill of material (BOM) of prototype A (material modules C, D, and E), then explodes the second level of bill of material (BOM) (material modules H, I, I, J, and K). At the second level of bill of material (BOM) there is a material module I being repeatedly exploded, as material module I belongs to parent material module C, as well as parent material module E, so as to be repeatedly exploded. Finally, the system drills down to the third level of bill of material (BOM) (material modules L, M, N, and O). At the third level of bill of material (BOM) there are material modules L and M being repeatedly exploded, as both L and M belong to parent material module I, which is one of sub-components to its parent material modules C and E, thus module I is repeatedly exploded.

After prototype A is exploded, the system then begins to explode the first level of material (BOM) of prototype B (material modules C, F, and G), then explodes the second level of bill of material (BOM) (material modules H, I, I, and J). At the second level of bill of material (BOM) there is a material module I being repeatedly exploded, as material module I belongs to parent material module C, and also belongs to parent material module F, thus module I is repeatedly exploded. Finally, the system drills down the third level of bill of material (BOM) (material modules L, M, L, M, and P). At the third level of bill of material (BOM) there are material modules L and M being repeatedly exploded, as both L and M belong to parent material module I, which is one of sub-components to its parent material modules C and F. The exploding process, therefore, is completed.

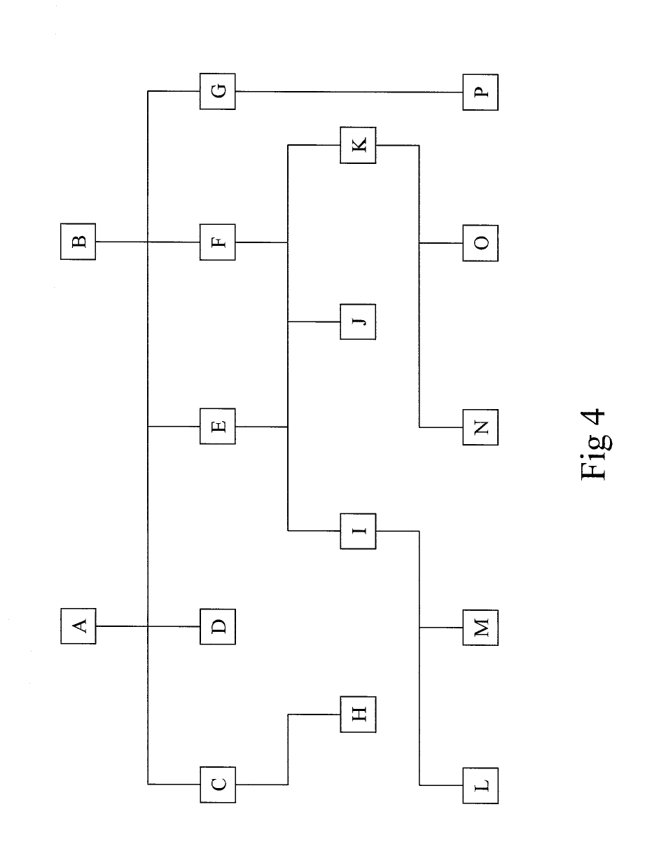

FIG. 4 is an exploded view of bills of material (BOM) according to the disclosed invention that illustrates the exploding method of bill of material (BOM) as follows.

The exploded method of this invention : first, the system explodes all bills of material (BOM) of respective prototypes (prototype A and B, for example), then combines the first level of bills of material (BOM) of both prototypes A and B, and then explodes the first level of bills of material (BOM) (material modules C, D, E, F, and G), followed the first level of bill of material (BOM) of both prototypes A and B being completely combined. When the first level of bills of material (BOM) of both prototypes A and B are exploded, the system drills down to the second level of bill of material (BOM) to combine bills of material (BOM) of both prototypes A and B and explode the second level of bill of material (BOM) (material modules H, I, J, and K), followed the second level of bills of material (BOM) being completely combined. When the second level bills of material (BOM) of both prototypes A and B are exploded, the system drills down to the third level to combine bills of material (BOM) of both prototypes A and B and explode the third level of bill of material (BOM) of both prototypes A and B (material modules L, M, N, O, and P). The exploding process is, therefore, completed.

Hence, the exploded method of bill of material (BOM) consists of the following steps: first, exploding all bills of material (BOM) of respective prototypes, then stratifying all levels of bills of material (BOM), according to assemble features of respective prototypes. Finally Combining and exploding components or parts at each level of all integrated bills of material (BOM).

This exploded method can largely reduce the burden to the system resources, enhance efficiency, and enable material management and distribution more effective.

In sum, conventionally known method of exploding bills of material (BOM) has to repeatedly explode material items to match the tree structure of bills of material (BOM). Take material module M as an example that it has been exploded for four times, which heavily occupies the hardware space and wastes the time for exploding. Therefore, this disclosed invention utilizes combination method to explode bills of material (BOM) for the following advantages that,

1) Each material is exploded only once to save time in exploding bills of material (BOM);

2) Common materials of respective prototypes are easy to be understood;

3) It saves resources of information system;

4) It shorten time for searching material modules (prototypes only need to be exploded once, no necessary to search various prototypes one-by-one);

5) It is no necessary to have duplicated storage so as to save memory space.

The invention in the form of the no demand trial run module material on hand checking method is disclosed herein. These and other variations, which will be understood by those skilled in the art, are intended to be within the scope of the invention as claimed below. As previously stated, detailed embodiments of the present invention are disclosed herein; however, it is to be understood that the disclosed embodiments are merely exemplary of the invention that may be embodied in various forms.

What is claimed is:

1. A material on hand checking method modules without demands and production orders relates to a method that employs to proceed the management and control of material shortage status without demands and production orders for trial-run prototypes/modules through an Enterprise Resource Planning (ERP) server of an enterprise end on the inventory management system in the manufacturing industry. The Enterprise Resource Planning (ERP) server can, therefore, decrease the risk of overstocks in inventory through a certain material exploding method. The disclosed method includes at least the following steps:
Receiving information of a trial-run prototype/module through the Enterprise Resource Planning (ERP) server;
Transferring the information of the trial-run prototype/module back to a storage media according to the Enterprise Resource Planning (ERP) server;
Exploding the bill of material (BOM) of the trial-run prototype/module through the Enterprise Resource Planning (ERP) server; and
Integrating the bill of material (BOM) to store it back to the storage media through the Enterprise Resource Planning (ERP) server.

2. The invention as recited in claim 1, wherein the information of the trial-run prototype/module includes at least: the facility and required quantity of the trial-run prototype/module.

3. The invention as recited in claim 1, wherein the storage media provides a plurality of columns to allow various contents in storage.

4. The invention as recited in claim 1, wherein the certain method of exploding the bill of material (BOM) comprises the following steps,
Exploding all bills of material (BOM) of the trial-run prototype/module;
Combining modules at the first level of bill of material (BOM);
Exploding the first level of bill of material (BOM);
Exploding the second level of bill of material (BOM); and
Repeatedly exploding each level of bill of material (BOM) to the last level of bill of material (BOM).

5. The invention as recited in claim 4, wherein the bill of material (BOM) is a product tree of an enterprise.

6. The invention as recited in claim 4, wherein the bill of material (BOM) comprises: at least one common material and at least one specific material.

7. The invention as recited in claim 6, wherein the common material relates to a general component or part needed for all prototypes/modules, and is evaluated by pre-set column through the Enterprise Resource Planning (ERP) server.

8. The invention as recited in claim 6, wherein the specific material relates to a particular component or part needed for respective prototypes/modules, the kind of components and parts among which do not overlap in common.

9. The invention as recited in claim 1, wherein the step that the Enterprise Resource Planning (ERP) server integrates the bill of material (BOM) is utilizing inventory quantity deducts reserved stock to generate an available quantity of the trial-run prototype/module.

10. The invention as recited in claim 1, wherein the step of storing the bill of material (BOM) back to the storage media is to store part numbers and quantities of stock-outs for the trial-run prototype/module into columns provided by the storage media.
